(19) United States
(12) Patent Application Publication
(10) Pub. No.: US 2026/0237067 A1
(43) Pub. Date: Aug. 13, 2026

(54) SYSTEM, CONTROL OF SYSTEM, AND NON-TRANSITORY COMPUTER READABLE MEDIUM

(71) Applicant: CANON KABUSHIKI KAISHA, Tokyo (JP)

(72) Inventor: MASATO UCHIHARA, Tokyo (JP)

(21) Appl. No.: 19/535,957

(22) Filed: Feb. 10, 2026

(30) Foreign Application Priority Data
Feb. 12, 2025 (JP) 2025-020726

(51) Int. Cl. G06T 7/00; G06F 3/01; G06F 3/0488; G06T 5/70

(52) U.S. Cl. CPC G06T 7/0012; G06F 3/011; G06F 3/016; G06F 3/0488; G06T 5/70; G06T 2207/10012; G06T 2207/20081; G06T 2207/30261

(57) ABSTRACT

A system according to the present disclosure includes one or more processors and/or circuitry configured to execute acquisition processing of acquiring one or more images representing an object, and execute replacement processing of replacing information on pixel values of some pixels among a plurality of pixels included in the one or more images with tactile information related to positions of the object corresponding to the some pixels.

### BACKGROUND

### Field of the Technology

The present disclosure relates to a system, a control of the system, and a non-transitory computer readable medium.

### Description of the Related Art

There is a known technology for providing stereoscopic vision by playing back two left and right images (stereo images), for which viewpoints are different from each other, on a head mounted display (HMD) so that the images can be viewed by the left and right eyes, respectively. There is also a known technology for allowing a user to virtually experience the sensation of touching an object by controlling vibrations in accordance with the movement and texture of the object, which is called haptics.

According to International Publication No. 2020/017261, the vibration of a stick is controlled according to a position where an operating object displayed in a stereo image in conjunction with a device held by a user collides with an object included in the stereo image. This provides tactile feedback to the user.

According to International Publication No. 2020/017261, tactile information needs to be recorded separately from image data, but in order to reduce the amount of data, a position where tactile information is added is limited to a certain region of the object.

However, according to International Publication No. 2020/017261, the presence of tactile information and image data needs to record or output a larger amount of data in order to achieve tactile reproduction compared to when tactile reproduction is not performed.

### SUMMARY

The present disclosure provides a technology for further reducing the amount of data to be recorded or output in order to achieve tactile reproduction.

A system according to the present disclosure includes one or more processors and/or circuitry configured to execute acquisition processing of acquiring one or more images representing an object, and execute replacement processing of replacing information on pixel values of some pixels among a plurality of pixels included in the one or more images with tactile information related to positions of the object corresponding to the some pixels.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a tactile sensation imparting system according to one or more aspects of the present disclosure.

FIG. 2 is a configuration diagram of an imaging apparatus according to one or more aspects of the present disclosure.

FIG. 3 is an example of a stereo image according to one or more aspects of the present disclosure.

FIG. 4 is a flowchart of generating tactile information according to one or more aspects of the present disclosure.

FIG. 5 is a diagram illustrating a tactile model according to one or more aspects of the present disclosure.

FIG. 6 is a diagram illustrating processing of transforming the tactile model according to one or more aspects of the present disclosure.

FIG. 7 is a flowchart of processing in a replacement unit according to one or more aspects of the present disclosure.

FIG. 8 is a diagram illustrating the replacement unit according to one or more aspects of the present disclosure.

FIG. 9 is a diagram illustrating a bit structure of tactile information and others according to one or more aspects of the present disclosure.

FIG. 10 is a diagram illustrating a disparity map according to one or more aspects of the present disclosure.

FIG. 11 is a diagram illustrating a playback apparatus according to one or more aspects of the present disclosure.

FIG. 12 is a configuration diagram of an HMD according to one or more aspects of the present disclosure.

FIG. 13 is a flowchart of image generation processing according to one or more aspects of the present disclosure.

FIG. 14 is a diagram illustrating the image generation processing according to one or more aspects of the present disclosure.

FIG. 15 is a flowchart of generating tactile information according to one or more aspects of the present disclosure.

FIG. 16 is a diagram illustrating generation of tactile information according to one or more aspects of the present disclosure.

FIG. 17 is a diagram illustrating a disparity map according to one or more aspects of the present disclosure.

FIG. 18 is a configuration diagram of an HMD according to one or more aspects of the present disclosure.

FIG. 19 is a flowchart of image generation processing according to one or more aspects of the present disclosure.

### DESCRIPTION OF THE EMBODIMENTS

### First Embodiment

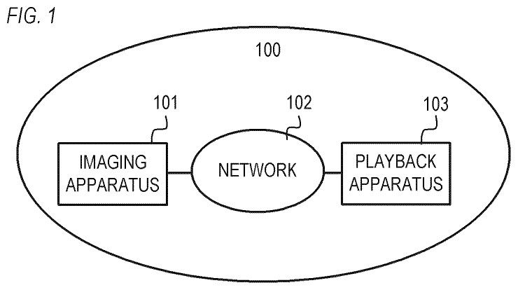

FIG. 1 illustrates a configuration of a tactile sensation imparting system 100 according to a first embodiment. The tactile sensation imparting system 100 includes an imaging apparatus 101, a network 102, and a playback apparatus 103. Note that the imaging apparatus 101 may have part or all of the configuration of the playback apparatus 103.

The imaging apparatus 101 is an electronic device that acquires stereo images and adds tactile information to the stereo image. The imaging apparatus 101 records the stereo images with the tactile information added. The stereo images with the tactile information added is transferred to the playback apparatus 103 via the network 102.

The playback apparatus 103 is an electronic device that plays back the stereo images acquired from the imaging apparatus 101. Thus, the playback apparatus 103 allows a user to view a stereoscopic image. Meanwhile, the playback apparatus 103 reproduces by using a haptic device a tactile sensation depending on an object based on the tactile information added to the stereo images, and feeds back the tactile sensation to the user.

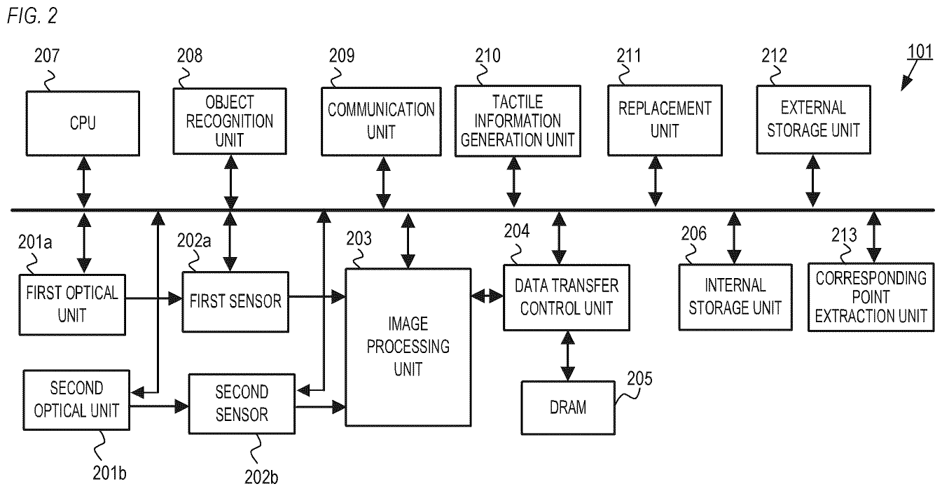

FIG. 2 illustrates a configuration of the imaging apparatus 101. The imaging apparatus 101 includes a first optical unit 201a, a second optical unit 201b, a first sensor 202a, a second sensor 202b, an image processing unit 203, a data transfer control unit 204, a DRAM 205, and an internal storage unit 206. The imaging apparatus 101 also includes a CPU 207, an object recognition unit 208, a communication unit 209, a tactile information generation unit 210, a replacement unit 211, an external storage unit 212, and a corresponding point extraction unit 213.

The first optical unit 201a and the second optical unit 201b are a pair of left and right optical units. The first optical unit 201a and the second optical unit 201b each include a lens, a diaphragm, and the like. The first optical unit 201a and the second optical unit 201b perform focus adjustment and exposure adjustment.

The first sensor 202a and the second sensor 202b are a pair of left and right sensors (such as CMOS). The first sensor 202a and the second sensor 202b each capture an image (analog image signal) by converting a formed optical image into an electrical signal. The first sensor 202a and the second sensor 202b each convert the analog image signal into digital image data by using an A/D conversion circuit.

The image processing unit 203 performs image processing (such as noise removal, sharpness, and YUV conversion processing) on the digital image data each output from the first sensor 202a and the second sensor 202b. Thus, the image processing unit 203 generates a pair of left and right stereo images. The image processing unit 203 further performs compression processing on each stereo image to generate a JPEG file or an MP4 file.

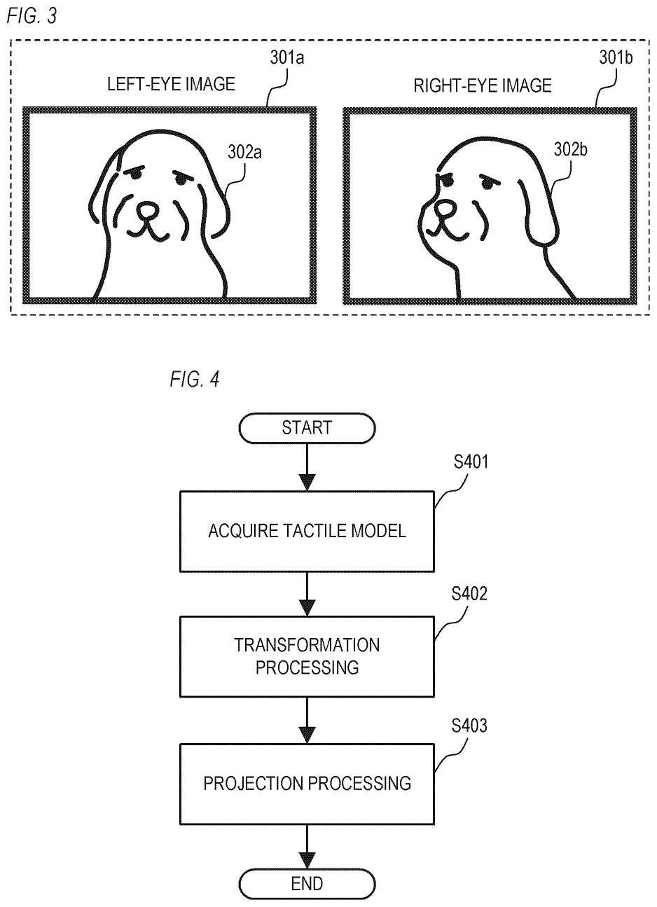

FIG. 3 illustrates an example of stereo images. A left-eye image 301a is an image captured by the first optical unit 201a. A right-eye image 301b is an image captured by the second optical unit 201b. There is a horizontal shift (hereinafter referred to as disparity) between an object 302b appearing in the right-eye image 301b and an object 302a appearing in the left-eye image 301a due to the difference in viewpoint position. This disparity allows the user to have a sense of depth when the stereo images are played back. In addition, by measuring the exact amount of the disparity, the distance to the object can be calculated.

The data transfer control unit 204 controls writing and reading of data to and from the DRAM 205. The data transfer control unit 204 is used when data such as stereo images and tactile information on which compression processing has been performed is temporarily held in the DRAM 205.

The internal storage unit 206 is a ROM or the like that stores programs for controlling the entire imaging apparatus 101 and information such as a tactile model, which will be described later.

The CPU 207 is a control unit that controls each component in the imaging apparatus 101 via a bus.

The object recognition unit 208 recognizes (identifies/detects) an object appearing in a stereo image.

The communication unit 209 performs input and output of data for the imaging apparatus 101 via an external network such as the Internet.

The tactile information generation unit 210 generates tactile information of the object detected by the object recognition unit 208. The processing performed by the tactile information generation unit 210 will be described in detail below.

The replacement unit 211 replaces information on pixel values of some pixels in the stereo image with tactile information based on the tactile information generated by the tactile information generation unit 210 and information on corresponding points extracted by the corresponding point extraction unit 213. Details of the processing performed by the replacement unit 211 will be described later.

The external storage unit 212 is an SD card or the like that can record and read data. The external storage unit 212 is used to save the stereo image.

The corresponding point extraction unit 213 extracts, for feature points detected in one of the left-eye image and the right-eye image, which are stereo images of the object, their respective corresponding points (points corresponding to the detected feature points) in the other of the left-eye image and the right-eye image. The corresponding points can be obtained by calculating, for a portion of the object region in each of the left-eye image and the right-eye image, their correlation values while moving coordinates in one of the images in a horizontal direction, and using the coordinate position with the highest correlation value. To calculate such a correlation value, for example, an equation using the sum of absolute differences represented by Equation 1 below can be used. Here, Pv(X-x, Y-y) represents the pixel value at coordinates (X-x, Y-y) in the right-eye image; and Pv′(X-x, Y-y) represents the pixel value at coordinates (X-x, Y-y) in the left-eye image. Note that X and Y represent the coordinate position of a feature point, and d is an amount of movement of the coordinates in the horizontal direction. In Equation 1, a correlation value is calculated for a small region of 9×9 pixels around the feature point.

$$\begin{matrix}[ Math . 1 ] & \\ SAD ( d ) = {\int }_{- 4}^{4} {\int }_{- 4}^{4} \vert P \begin{matrix}v ( X - x , Y - y ) - {Pv}^{′} & ( X - d - x , Y - y ) \vert\end{matrix} dxdy & ( 1 )\end{matrix}$$

In the following description, it is assumed that feature points are detected from the right-eye image, and information on pixel values of some pixels (pixels at the feature points) in the right-eye image is replaced with tactile information. However, feature points may be detected from the left-eye image, and information on the pixel values of some pixels in the left-eye image may be replaced with tactile information.

### Processing in Tactile Information Generation Unit

The processing performed by the tactile information generation unit 210 will be described with reference to a flowchart illustrated in FIG. 4.

In S401, the tactile information generation unit 210 detects, based on information on an object detected by the object recognition unit 208, a plurality of feature points for the object. Then, the tactile information generation unit 210 acquires, based on the information on the object, a tactile model that holds information necessary to reproduce a tactile sensation for each feature point.

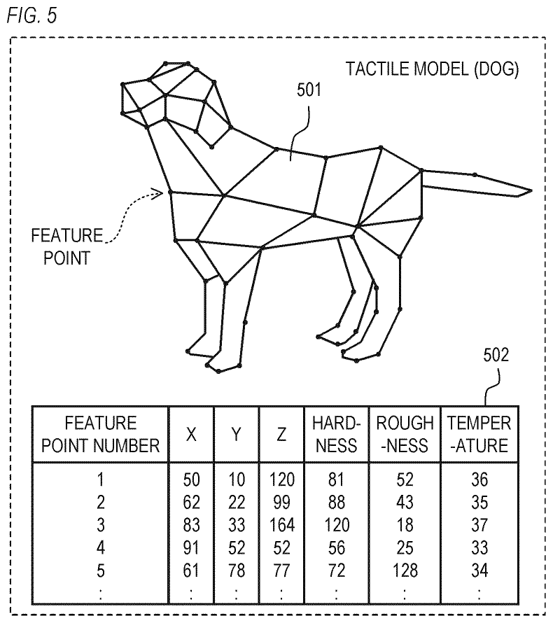

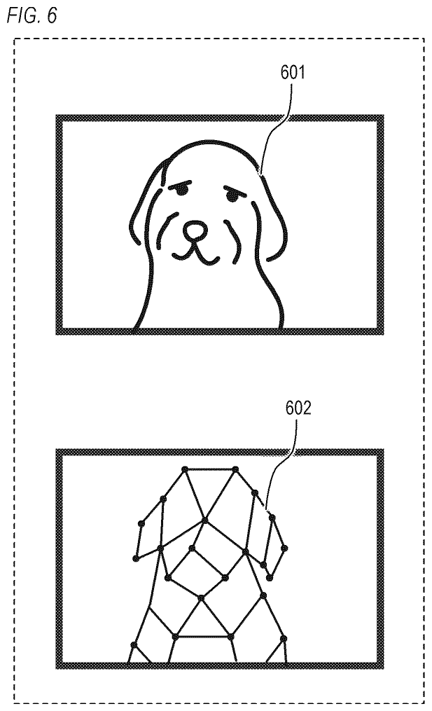

FIG. 5 illustrates an example of a tactile model. In FIG. 5, the tactile model has an information group 501 that holds information necessary to reproduce tactile sensations, such as the positions of feature points of a dog, which is an object. The tactile model also has a list 502 that includes, for each feature point, information such as a three-dimensional coordinate position (X, Y, Z) and a hardness, roughness, and temperature of the object's surface. The tactile model may be read from information held in the internal storage unit 206 or may be acquired from an external database via the communication unit 209.

In S402, the tactile information generation unit 210 performs processing of transforming (rotation, enlargement or reduction) of the tactile model in accordance with the distance to and orientation of the object. The distance Z to the object can be calculated using the following Equation 2.

$$Z = B \times f / D \qquad ( 2 )$$

In the above Equation 2, f is a focal length represented by the distance between “the first optical unit 201a and the second optical unit 201b” and “the first sensor 202a and the second sensor 202b”. B is a base line length representing the distance between the first optical unit 201a and the second optical unit 201b. D is a disparity of the object region. D can be obtained by performing, in pixel-by-pixel increments in a horizontal direction, correlation calculations such as the sum of absolute differences on a portion of the object region in each of the left-eye image and the right-eye image, and using the coordinate position with the highest correlation value. In a tactile model that has been rotated, enlarged, or reduced in accordance with the distance to and orientation of the object, only the coordinate position (X, Y, Z) of each feature point is changed.

In S403, the tactile information generation unit 210 performs processing of projecting (projective transformation, perspective projection transformation, etc.) the tactile model so that the feature points of the transformed tactile model overlap the feature points of the object appearing in the captured image.

A tactile model projected in accordance with the object appearing in the captured image will be described with reference to FIG. 6. The feature points of the tactile model 602 are arranged in accordance with the feature points of an object 601 in a stereo image. In addition, “information such as hardness, roughness, and temperature” held for each feature point is associated with a coordinate position of the stereo image. Note that feature points that an object appearing in a stereo image does not have or feature points that have a certain distance away may be deemed not to be targets for providing a tactile sensation and may be deleted. In other words, tactile information for a feature point may be generated only if it has a distance Z shorter than a certain distance.

Through the above processing, tactile information corresponding to the object appearing in the stereo image can be generated.

### Processing in Replacement Unit

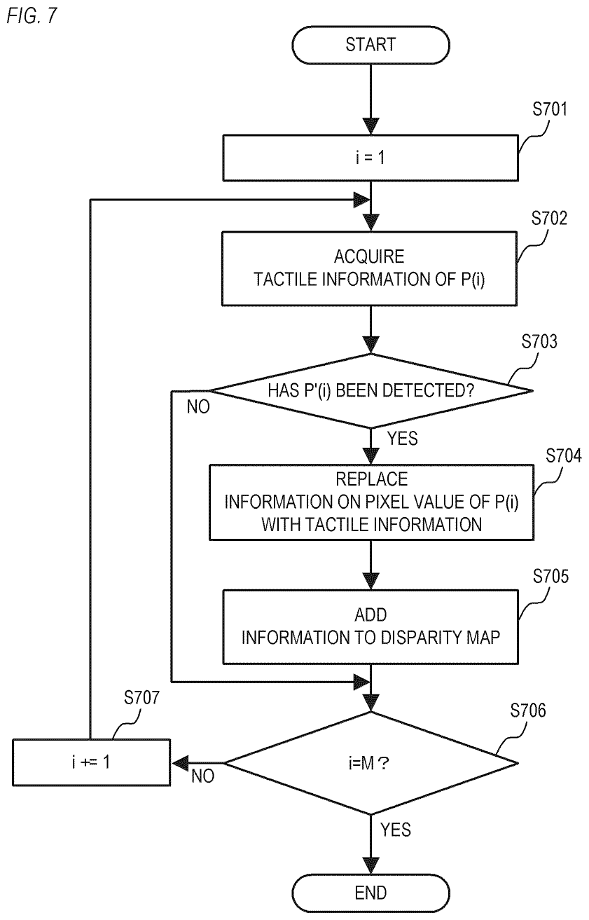

The processing performed by the replacement unit 211 will be described with reference to a flowchart illustrated in FIG. 7. To improve the accuracy of tactile reproduction, it is necessary to generate tactile information using a tactile model with a higher density of feature points. This increases the amount of tactile information data to be generated. Therefore, in the first embodiment, the replacement unit 211 replaces part of the stereo image data with tactile information. This achieves a reduced amount of data stored.

In S701, the replacement unit 211 sets a variable i, which stores a number indicating a feature point to be referenced, to an initial value (=1). In the following description, it is assumed that the number of feature points of an object detected from a right-eye image is M.

In S702, the replacement unit 211 reads from the DRAM 205 the tactile information of a feature point P(i) corresponding to the variable i.

In S703, the replacement unit 211 determines whether or not a corresponding point P′(i) has been detected for the feature point P(i) by the corresponding point extraction unit 213. If it is determined that the corresponding point P′(i) has been detected, the processing proceeds to S704. If it is determined that the corresponding point P′(i) has not been detected, the processing proceeds to S706.

In S704, the replacement unit 211 replaces information on a pixel value of a pixel in the right-eye image with tactile information of positions in the object that correspond to the pixel. Specifically, the replacement unit 211 replaces information on the pixel value of the feature point P(i) with the tactile information of the feature point P(i). Note that the replacement unit 211 may replace the information on the pixel value of the feature point P(i) with the tactile information of the feature point P(i) only when the distance to the feature point P(i) is shorter than a threshold value.

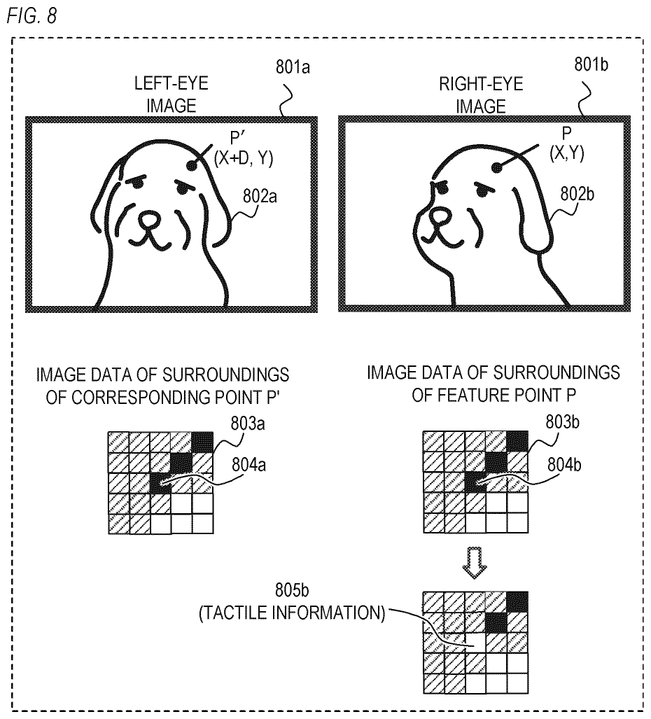

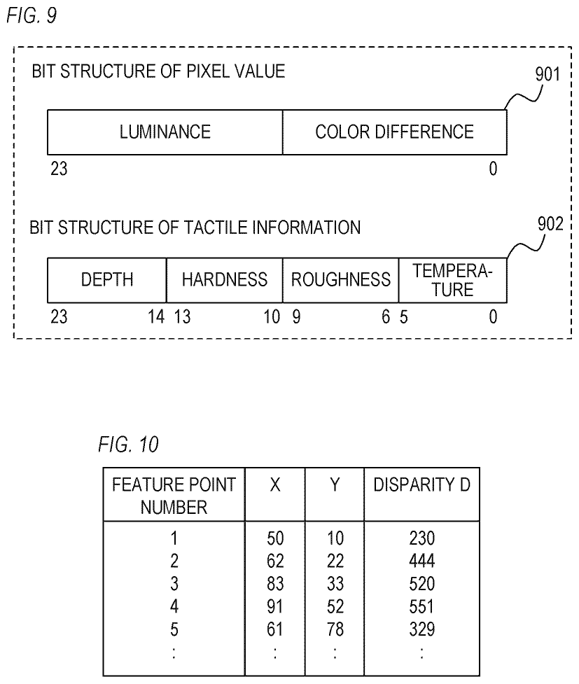

Processing of replacing information on a pixel value with tactile information will be described with reference to FIGS. 8 and 9. A left-eye image 801a illustrated in FIG. 8 is an image corresponding to the user's left eye. A right-eye image 801b is an image corresponding to the user's right eye. An object 802a is an object included in the left-eye image 801a. An object 802b is an object included in the right-eye image 801b. A feature point P in the right-eye image 801b is located at coordinates (X, Y). A corresponding point P′ in the left-eye image 801a is a point corresponding to the feature point P in the right-eye image 801b. The coordinates of the corresponding point P′ are represented as (X+D, Y) using a disparity D.

Image data 803a is a schematic diagram of image data of the corresponding point P′ and its surroundings in the left-eye image. In the image data 803a, the pixel of the corresponding point P′ is a pixel 804a. Image data 803b is a schematic diagram of image data of the feature point P and its surroundings. In the image data 803b, the pixel of the feature point P is a pixel 804b. Although there is a slight difference in pixel value between the pixel 804a and the pixel 804b due to a difference in viewpoint position, the correlation between the two pixels is high. Therefore, in S704, the information on the pixel value of the pixel of the feature point P at a pixel 805b is replaced with the tactile information of the feature point P.

FIG. 9 illustrates an overview of bit structures of a pixel value and tactile information. A pixel value structure 901 represents the structure of a pixel value before being replaced with tactile information (a pixel value before replacement). One pixel is composed of 12 bits of luminance information and 12 bits of color-difference information. Tactile information 902 represents an example of tactile information to be replaced with a pixel value. The tactile information 902 includes 10 bits of depth (distance Z), 4 bits of hardness, 4 bits of roughness, and 6 bits of temperature information.

In S705, the replacement unit 211 adds information about a feature point P(i) to a disparity map (disparity information). As illustrated in FIG. 10, the disparity map is a list that has, for each feature point, “information on X and Y coordinates in the image and a disparity D of the corresponding point detected at that coordinate position”.

In S706, the replacement unit 211 determines whether or not the variable i is M. If it is determined that the variable i is not M, the processing proceeds to S707 If it is determined that the variable i is M, the processing of this flowchart ends. Note that, if it is determined that the variable i is M, the replacement unit 211 records the stereo image in which the pixel values of some pixels have been replaced with tactile information in the external storage unit 212 together with the disparity map.

In S707, the replacement unit 211 increments the variable i by one.

As described above, by replacing the information on the pixel value of a pixel where a corresponding point is present with tactile information, the amount of data can be reduced. The pixel values of the pixels in the right-eye image that have been replaced with tactile information can be restored (estimated) by interpolating based on the pixel values of the pixels in the left-eye image.

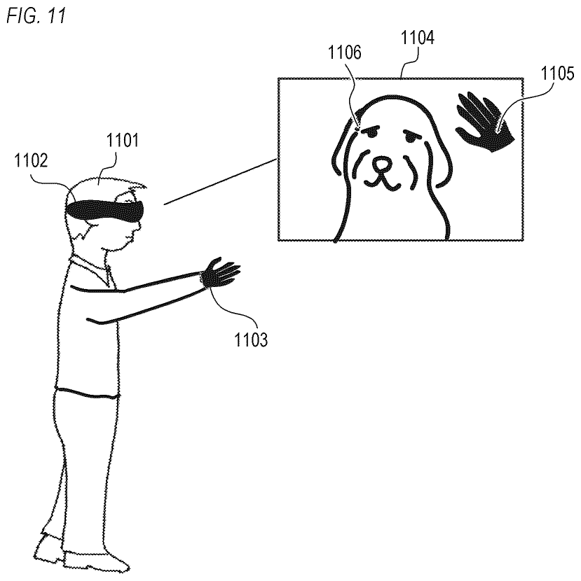

Processing of playing back stereo images by an HMD 1102, which is the playback apparatus 103, will be described with reference to FIG. 11. FIG. 11 is a diagram illustrating a state in which a user 1101 is wearing the HMD 1102. The HMD 1102 receives stereo images from the imaging apparatus 101 via the network 102. The user 1101 uses the HMD 1102 to view the stereo images.

The user 1101 wears a haptic glove 1103, which is a glove-type haptic device. The haptic glove 1103 is linked to the space in the stereo images played back by the HMD 1102. The haptic glove 1103 is displayed as a glove-shaped icon 1105 in a stereo image 1104 that the user 1101 is viewing. When the user 1101 operates the haptic glove 1103 and then the icon 1105 comes into contact with an object 1106 appearing in the stereo image, the HMD 1102 detects the collision. Accordingly, the HMD 1102 generates tactile information for the contact position and transmits that information to the haptic glove 1103. The haptic glove 1103 then controls vibrations based on the received tactile information to feed back a tactile sensation to the user 1101.

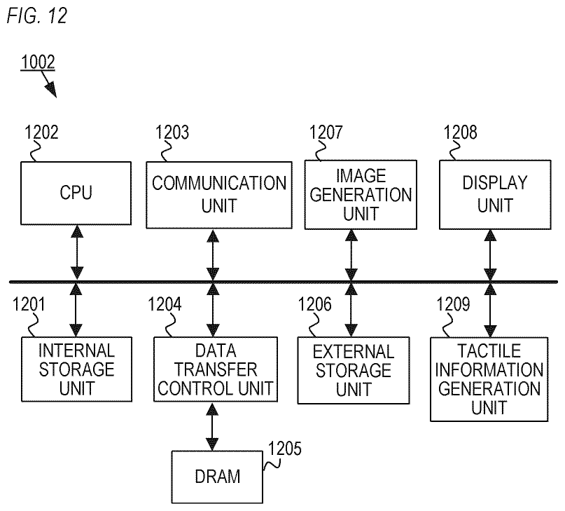

FIG. 12 illustrates the detailed configuration of the HMD 1002. The HMD 1002 includes an internal storage unit 1201, a CPU 1202, a communication unit 1203, a data transfer control unit 1204, a DRAM 1205, an external storage unit 1206, an image generation unit 1207, a display unit 1208, and a tactile information generation unit 1209.

The internal storage unit 1201 includes a ROM or the like that stores programs for controlling the entire HMD 1002.

The CPU 1202 is a control unit that performs various controls in accordance with programs stored in the internal storage unit 1201.

The communication unit 1203 performs input and output of data via an external network.

The data transfer control unit 1204 controls writing and reading of data to and from the DRAM 1205.

The external storage unit 1206 is an SD card or the like that can record and read data. The external storage unit 1206 is used to save compressed stereo images and disparity maps acquired over the network 102 via the communication unit 1203.

The image generation unit 1207 reads compressed stereo images saved in the DRAM 1205 and performs decompression processing on the stereo images. Then, the image generation unit 1207 refers to the disparity map and estimates (generates) information on the pixel values of the pixels replaced with tactile information in the decompressed stereo images. Details of the processing performed by the image generation unit 1207 will be described later.

The display unit 1208 includes a pair of left and right display elements that allow the user to view stereo images. The display unit 1208 displays the stereo images generated by the image generation unit 1207.

The tactile information generation unit 1209 generates tactile information according to a contact position between the glove-shaped icon (icon 1105 in FIG. 11) operated by the user and the object appearing in the image. The tactile information generation unit 1209 transmits the generated tactile information to the haptic glove (1103 in FIG. 11) via the communication unit 1203. Details of the processing performed by the tactile information generation unit 1209 will be described later.

### Processing in Image Processing Unit

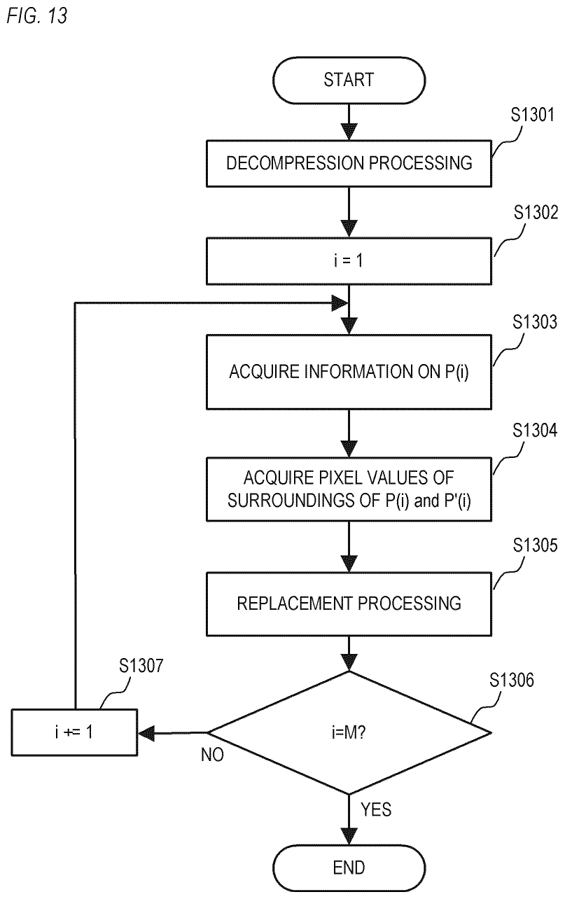

Details of the restoration (generation; estimation) of stereo images performed by the image generation unit 1207 will be described with reference to a flowchart in FIG. 13.

In S1301, the image generation unit 1207 performs decompression processing on the compressed stereo images saved in the DRAM 1205. The image generation unit 1207 saves the decompressed stereo images in the DRAM 1205.

In S1302, the image generation unit 1207 sets a variable i, which stores a number indicating a feature point to be referenced, to an initial value (=1). In the following description, it is assumed that the number of feature points detected in a stereo image (i.e., the number of feature points stored in the disparity map) is M.

In S1303, the image generation unit 1207 reads the coordinate position (X, Y) and the value of a disparity D of a feature point P(i), which correspond to the variable i, from the disparity map held in the DRAM 1205.

In S1304, the image generation unit 1207 acquires from the stereo images the pixel value of the feature point P(i) and the pixel values of its surrounding pixels, and the pixel value of the corresponding point P′(i).

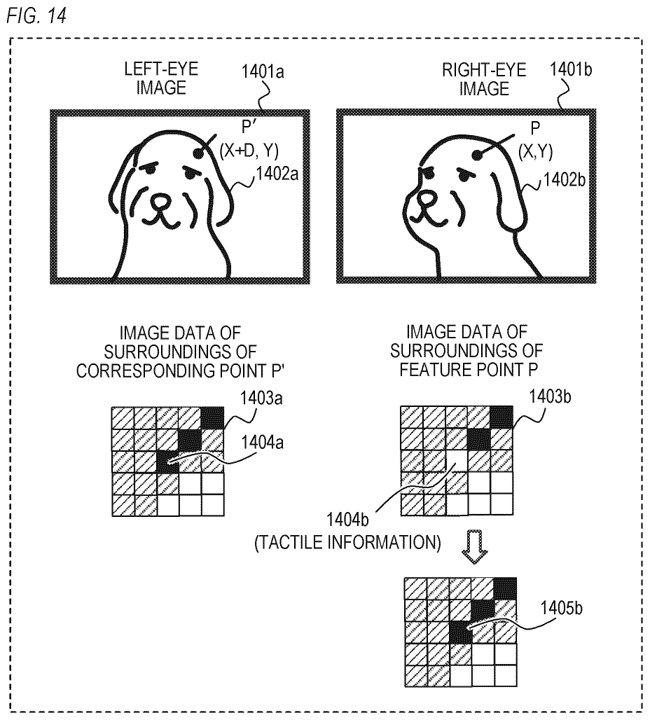

FIG. 14 illustrates an overview of pixel values of surrounding pixels of a feature point and its corresponding point. An image 1403b is an image of surroundings of the coordinates (X, Y) of a feature point P in a right-eye image 1401b. At a pixel position 1404b, the information on the pixel value has been replaced with tactile information. An image 1403a is an image of surroundings of the coordinates (X+D, Y) of a corresponding point P′ in a left-eye image 1401a.

In S1305, the image generation unit 1207 replaces the tactile information of the feature point P(i) with the information on a pixel value representing the color and luminance of the stereo image. The image generation unit 1207 calculates a difference between the pixel value of the corresponding point P′(i) acquired in S1304 and an average of the pixel values of pixels surrounding the feature point P(i). If the calculated difference is greater than a predetermined value, the image generation unit 1207 sets the average of the pixel values of the pixels surrounding the feature point P(i) as a new pixel value for the feature point P(i), without using the pixel value of the corresponding point P′(i). If the calculated difference is smaller than the predetermined value, the image generation unit 1207 sets the pixel value of the corresponding point P′(i) as a new pixel value for the feature point P(i). This processing makes it possible to prevent significant degradation in image quality when a shift occurs in the position where the corresponding point P′(i) was detected. For example, the image surrounding the feature point P(i) in which the tactile information has been replaced is an image 1405b illustrated in FIG. 14.

In S1306, the image generation unit 1207 determines or not whether the variable i is M. If it is determined that the variable i is not M, the processing proceeds to S1307 If it is determined that the variable i is M, the processing of this flowchart ends.

In S1307, the image generation unit 1207 increments the value of the variable i by one.

### Processing in Tactile Sensation Generation Unit

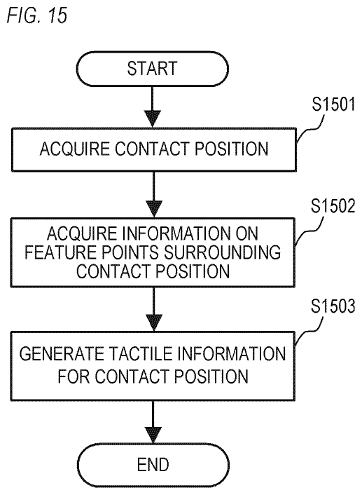

The generation of tactile information performed by the tactile information generation unit 1209 will be described with reference to a flowchart in FIG. 15.

In S1501, the tactile information generation unit 1209 detects a contact position between the glove-shaped icon (icon 1105 in FIG. 11) operated by the user and the object appearing in the image.

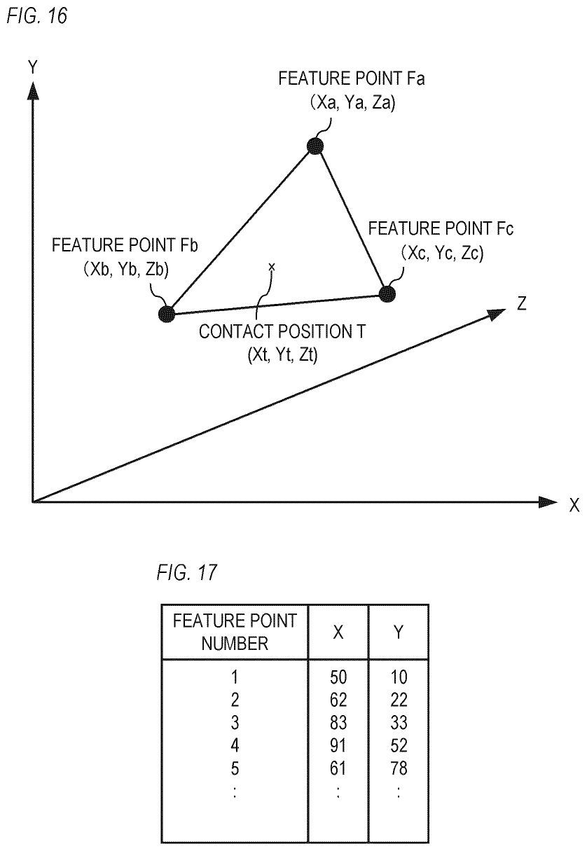

In S1502, the tactile information generation unit 1209 searches the disparity map for feature points surrounding the contact position based on the X and Y coordinates of the contact position. Then, the tactile information generation unit 1209 extracts information on the feature points. Note that the feature points to be extracted may be limited to those with “pixel values within a certain range of color or luminance from the pixel value at the contact position”. In this case, tactile information of feature points that are highly correlated with the contact position T can be extracted, improving the accuracy of tactile reproduction. In the following description, it is assumed that feature points Fa, Fb, and Fc surrounding the contact position T have been extracted as illustrated in FIG. 16.

In S1503, the tactile information generation unit 1209 generates tactile information for the contact position T by interpolation processing based on the coordinate information of each of the contact position T and the feature points Fa, Fb, and Fc.

For the interpolation processing, a “nearest neighbor method” can be used, which uses as the tactile information for the contact position T the information on the feature point closest to the contact position T. In addition, for the interpolation processing, a bilinear method can be used, which performs weighted addition on the pieces of tactile information of the feature points according to the distance from the contact position T to each feature point. As an example of an equation for the bilinear interpolation, an equation for calculating St, which indicates the hardness at the contact position T, is given in the following Equation 3.

$$St = K ( Sa / La + Sb / Lb + Sc / Lc ) \qquad ( 3 )$$

Here, Sa represents the hardness at the feature point Fa; Sb represents the hardness at the feature point Fb; Sc represents the hardness at the feature point Fc; La represents the Euclidean distance from the contact position T to the feature point Fa; Lb represents the Euclidean distance from the contact position T to the feature point Fb; Lc represents the Euclidean distance from the contact position T to the feature point Fc; and K is a coefficient used to adjust the weighting coefficients for weighted addition such that the sum of them becomes 1. For other tactile information (roughness, temperature), the roughness and temperature at the contact position T can be calculated using the same processing as for the hardness.

According to first embodiment, by replacing information on the pixel values of some pixels in a captured image, which is one of the stereo images, with tactile information, the amount of data of the stereo image for storage can be reduced. In addition, by interpolating the pixel values at pixel positions replaced with the tactile information when playing back the stereo image, degradation in image quality can be reduced. Furthermore, by generating tactile information for a contact position based on the tactile information in the stereo image, a highly accurate tactile sensation can be reproduced.

### Second Embodiment

In the first embodiment, when information on some pixel values in a stereo image is replaced with tactile information, the coordinate position (X, Y) and the disparity D of a feature point P replaced with the tactile information are stored together with the stereo image. On the other hand, in the second embodiment, by extracting a corresponding point P′ for playback, the amount of data to be saved for recording is further reduced. The basic configuration of the second embodiment is the same as that of the first embodiment, and therefore, only the differences will be described.

The information added to the disparity map in S705 of the flowchart illustrated in FIG. 7 is limited to only the feature point numbers and the coordinate positions (X, Y), as illustrated in FIG. 17.

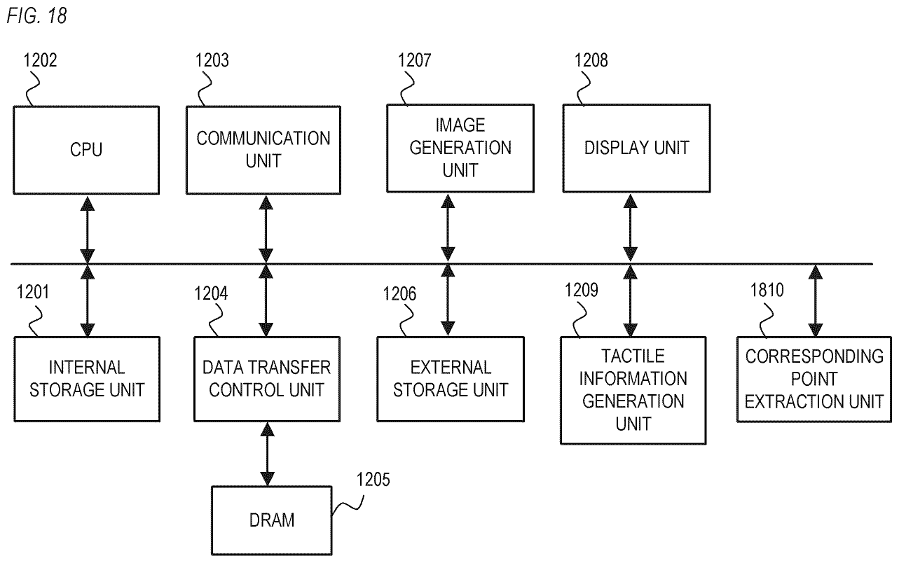

As illustrated in FIG. 18, the playback apparatus 103 according to the second embodiment additionally includes a corresponding point extraction unit 1810 as compared to the configuration according to the first embodiment (FIG. 12).

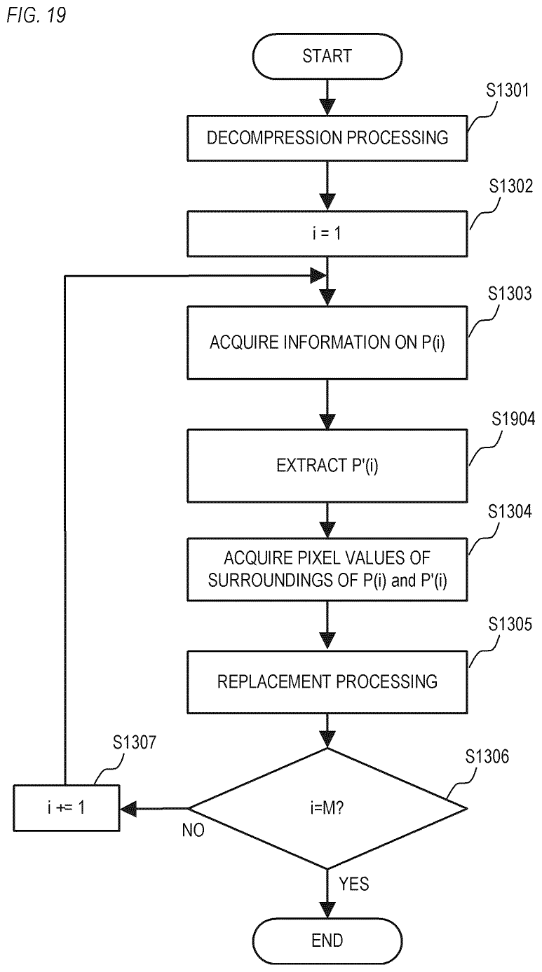

A flowchart of FIG. 19 illustrating processing of the image generation unit 1807 additionally includes processing of extracting a corresponding point P′(i) in S1904 as compared to the flowchart of the first embodiment (FIG. 13).

The method to be used for extracting corresponding points by the corresponding point extraction unit 1810 in S1904 can be the same as the method for calculating corresponding points by the corresponding point extraction unit 213 in the first embodiment. Note that in the second embodiment, a central portion of a small region (pixel of interest) is replaced with tactile information, and therefore, correlation calculations such as the sum of all differences may be performed on a surrounding region excluding the pixel of interest.

According to the second embodiment, the amount of information of a disparity map to be recorded in conjunction with recording of a stereo image can be reduced, thereby enabling a further reduction in the amount of data.

### Modified Example

Note that, in each of the above-described embodiments, the tactile sensation imparting system 100 embeds tactile information in one of the stereo images, and interpolates (restores; estimates) the original pixel values of the one image based on the other image. However, instead of stereo images, a single image may be used. In this case, for example, in each of the above-described embodiments, the tactile sensation imparting system 100 embeds tactile information in some pixels of one image, and restores the original pixel values of those pixels based on pixels surrounding those pixels. Note that the single image is not limited to an object, and as long as it is an image that represents an object, it may be a captured image of the object or an image in a virtual space.

For example, when a plurality of users view a same space, a first stereo image and a second stereo image may be acquired by capturing the same space at the same time. In this case, the tactile sensation imparting system 100 may embed tactile information in the first stereo image, and restore the original pixel values of the first stereo image based on the second stereo image.

Furthermore, in each of the above-described embodiments, the imaging apparatus 101 both captures images and generates tactile information. However, the imaging apparatus 101 may only capture images, and the generation of tactile information may be performed by another apparatus.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, the amount of data to be recorded or output in order to achieve tactile reproduction can be further reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020726, filed Feb. 12, 2025, which is hereby incorporated by reference herein in its entirety.

What is claimed is:

1. A system comprising one or more processors configured to:
execute acquisition processing of acquiring one or more images representing an object; and
execute replacement processing of replacing information on pixel values of some pixels among a plurality of pixels included in the one or more images with tactile information related to positions of the object corresponding to the some pixels.

2. The system according to claim 1, wherein the tactile information includes information on at least one of hardness, unevenness, and temperature.

3. The system according to claim 1, wherein the tactile information is acquired according to the object.

4. The system according to claim 1, wherein the one or more processors further execute generation processing of generating, in a case where information on pixel values of some pixels among a plurality of pixels included in the one or more images has been replaced with tactile information, tactile information corresponding to pixels that have not been replaced with the tactile information.

5. The system according to claim 1, wherein the one or more processors further execute generation processing of generating, in a case where contact between a user and the object is detected, tactile information corresponding to a pixel at a position of the contact based on the tactile information corresponding to a pixel having a pixel value within a predetermined range from a pixel value of the pixel at the position of the contact among a plurality of pixels in a range surrounding the position of the contact in the one or more images.

6. The system according to claim 1, wherein the one or more images are stereo images including a first image and a second image.

7. The system according to claim 6, wherein the one or more processors further perform estimation processing of estimating, in a case where information on pixel values in the first image has been replaced with tactile information, the pixel values in the first image before being replaced with the tactile information, based on information on pixel values in the second image.

8. The system according to claim 7, wherein the one or more processors further perform determination processing of determining whether or not a second position corresponding to a first position in the first image has been detected in the second image.

9. The system according to claim 8, wherein in a case where it is determined in the determination processing that the second position has been detected, in the replacement processing, information on a pixel value of a pixel at the first position is replaced with tactile information related to the first position of the object.

10. The system according to claim 8, wherein
the one or more processors further perform calculation processing of calculating a distance to the object, and
in a case where the distance is shorter than a threshold value, in the replacement processing, information on a pixel value of a pixel at the first position is replaced with tactile information related to the first position of the object.

11. The system according to claim 8, wherein
the one or more processors further perform control processing of performing, in a case where information on a pixel value of a pixel at the first position is replaced with tactile information, control to store the stereo images and disparity information on a storage, and
the disparity information includes information related to the first position and the second position.

12. The system according to claim 11, wherein in the estimation processing, a pixel value of a pixel at the first position of the first image before being replaced with the tactile information is estimated based on the disparity information and information on a pixel value of a pixel at the second position in the second image.

13. The system according to claim 1, wherein the information on the pixel values includes information on at least one of color difference and luminance.

14. A control method of a system, comprising:
acquiring one or more images representing an object; and
replacing information on pixel values of some pixels among a plurality of pixels included in the one or more images with tactile information related to positions of the object corresponding to the some pixels.

15. A non-transitory computer readable medium that stores a program, wherein the program causes a computer to execute a control method of a system, the control method comprising:
acquiring one or more images representing an object; and
replacing information on pixel values of some pixels among a plurality of pixels included in the one or more images with tactile information related to positions of the object corresponding to the some pixels.
